(19) United States
(12) Patent Application Publication
(10) Pub. No.: US 2004/0153363 A1
(43) Pub. Date: Aug. 5, 2004

(54) Interactive display advertising providing game play through instant messaging technology

(76) Inventor: Matthew D. Stehling, Franksville, WI (US)

Correspondence Address: Donald J. Ersler, 725 Garvens Avenue, Brookfield, WI, 53005, US

(21) Appl. No.: 10/357,581

(22) Filed: Feb. 4, 2003

(51) Int. Cl. G06F 17/60

(52) U.S. Cl. 705/14

(57) ABSTRACT

Interactive display advertising providing game play through instant messaging technology includes at least one game server connected to the Internet and an Internet communication device. Each Internet user installs a game client on their Internet communication device for communication with the at least one game server. The game client is capable of receiving and displaying a game document. The game document includes a graphic and a URL of a sponsor. The sponsor pays for the cost of sending the game to Internet users, so that the sponsor may advertise their product or service on the game client. The games are preferably randomly sent out to a different list of Internet users. The Internet users who send a correct modified game document within a maximum period of time will be recorded as eligible winners. A winner will be drawn from the among the eligible winners.

### BACKGROUND OF THE INVENTION

1. Field of the Invention

The present invention relates generally to advertising on Internet-ready devices and more specifically to interactive display advertising providing game play through instant messaging technology, which provides an incentive for users of the Internet to consider the product or service offered in the advertisement.

2. Discussion of the Prior Art

Users of the Internet are constantly bombarded with banner advertisements, active advertisements and pop-up advertisements. Most Internet users have come so accustomed to the banner active, and pop-up advertisements that they ignore them due to over exposure. Further, there are numerous software programs, which will completely block pop-up and active advertisements. There must be some incentive for a user of the Internet to comprehend an advertisement; such that the advertised product or service is actually considered by the Internet user.

Accordingly, there is a clearly felt need in the art for interactive display advertising providing game play through instant messaging technology, which increases the chance that an Internet user will seriously consider a product or service by offering the incentive of playing a game.

### SUMMARY OF THE INVENTION

The present invention provides interactive display advertising providing game play through instant messaging technology, which increases the chance that a product or service will be seriously considered by an Internet user. The interactive display advertising providing game play through instant messaging technology (interactive display advertising) includes at least one game server connected to the Internet and an Internet communication device. The Internet communication device must be able to receive and transmit information to the Internet. The Internet communication device could be a computer, cell phone, or any other suitable Internet communication device. The at least one game server includes a database of games, a database of users, a question document builder, an application interface and an answer evaluation program. The database of games includes both games and questions.

Preferably, each Internet user goes to an Internet game website to download a game client. A client is a device for graphically displaying data, such as a window or an applet. The game client is installed on the Internet user's Internet communication device. Information concerning the Internet user will be sent to the game server upon installation of the game client. Once the game client is installed, the Internet user will be able to receive game documents from the at least one game server. The game client is capable of receiving and displaying the game document. The game document contains a trivia question, a crossword puzzle, or any other suitable game. The game document will most importantly include a graphic and a web address of a sponsor. The sponsor will pay a fee to advertise some product or service. A multimedia advertisement of the sponsor's product or service is preferably displayed for a period of time, before the game may be played. The Internet user will then have a chance to play a game or answer a question.

The question document builder includes the capability of picking a game or a question from the database of games. The game or question is converted into the game document by the application interface. The game document is capable of being received by the game client. Picking of a game or question preferably occurs over random intervals of time. However, games and questions may also be manually retrieved by the application interface. The game document is sent to a game queue on the at least one game server. The application interface constantly monitors the game queue. The application interface is activated by reading a game document in the game queue. The application interface also decides, which Internet addresses should receive the game document. The game document is sent shortly after it appears in the game queue.

Preferably, a different selection of Internet users receive the game document each time a new game document is sent out. The game document is displayed in the game client. A sponsor's multimedia advertisement preferably appears first in the game client. Then the game contained in the game document appears in the game client. The sponsor's graphical information may still be displayed after the game appears in the game client. The selected Internet users play the game or answer the question as soon as possible.

A modified game document is sent back to the at least one Internet game server, after the game is completed or the question answered. The application interface reviews the modified game document for a modified record. Those modified game documents with the correct modified record are placed in a correct queue. The answer evaluation program will review the Internet users placed in the correct queue to make sure that the game was completed within a maximum period of time or a question was answered within a maximum period of time. Those users who completed the game or answered the question within the maximum time period are placed in an eligible winners queue. Prize drawing software determines at least one winner from the eligible winners. The at least one winner receives at least one prize.

Accordingly, it is an object of the present invention to provide interactive display advertising, which increases the chance that an Internet user will seriously consider a product or service by offering the incentive of playing a game.

These and additional objects, advantages, features and benefits of the present invention will become apparent from the following specification.

### BRIEF DESCRIPTION OF THE DRAWINGS

FIG. 1 is a block diagram of hardware required for interactive display advertising in accordance with the present invention.

FIG. 2 is a flow chart of the process sequence of interactive display advertising in accordance with the present invention.

FIG. 3 is a front view of a game client with a multimedia display of interactive display advertising in accordance with the present invention.

FIG. 4 is a front view of a game client with a display of a game of interactive display advertising in accordance with the present invention.

### DETAILED DESCRIPTION OF THE PREFERRED EMBODIMENTS

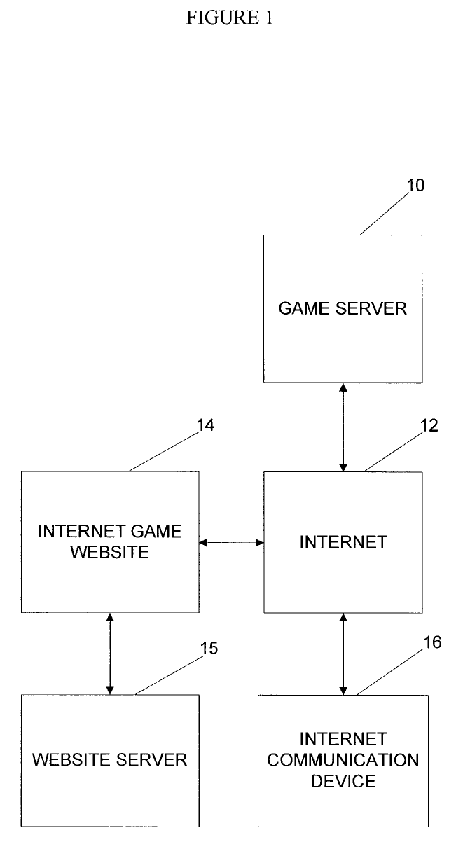

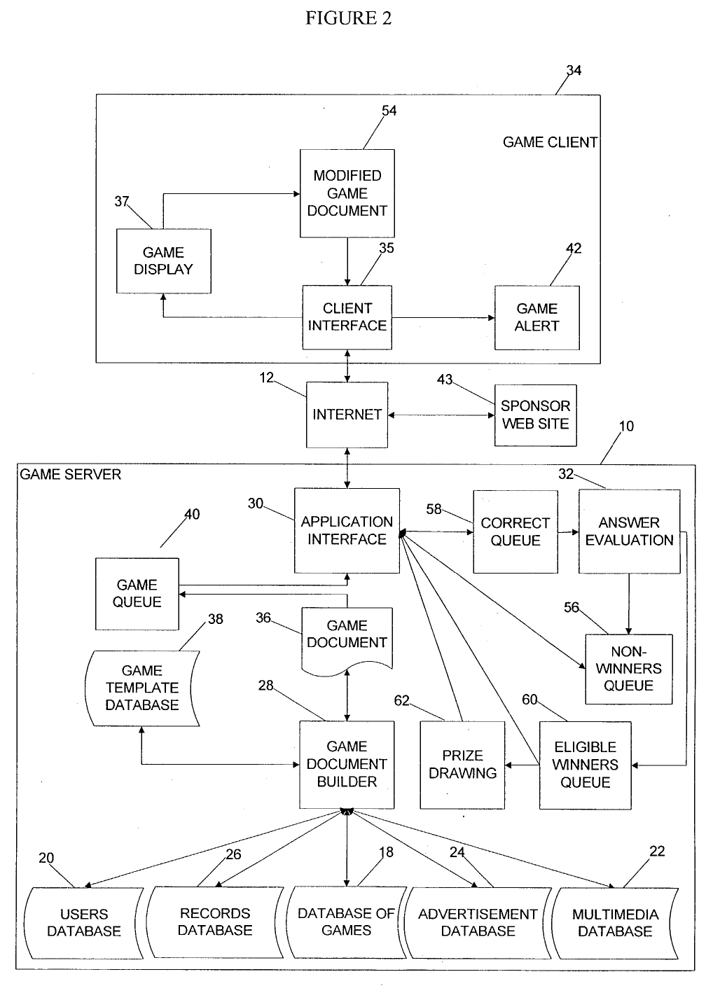

With reference now to the drawings, and particularly to FIG. 1, there is shown a block diagram of hardware required for interactive display advertising. The interactive display advertising providing game play through instant messaging technology (interactive display advertising) includes at least one game server 10 connected to the Internet 12 and an Internet communication device 16. An Internet game website 14 is preferably connected to a website server 15. The Internet communication device 16 must be able to receive and transmit information to and from the Internet 12. The Internet communication device 16 could be a computer, cell phone, or any other suitable Internet communication device. With reference to FIG. 2, the at least one game server 10 includes a database of games 18, a database of users 20, a multimedia database 22, an advertisement database 24, a records database 26, a game document builder 28, an application interface 30 and an answer evaluation program 32. The database of games 18 includes both games and questions.

Each Internet goes to the Internet game website 14 to download a game client 34. The game client 34 could also be obtained from some type of storage media, such as a compact disc. A client is a device for graphically displaying data, such as a window or an applet. The game client 34 is installed on the Internet user's Internet communication device 16. The game client 34 includes a client interface 35 and a game display 37. The client interface 35 receives and sends data to the internet 12. Information concerning the Internet user (including email address and IP address) will be sent to the records database 26 in the game server 10, upon installation of the game client 34. Once the game client 34 is installed, the Internet user will be able to receive a game document 36 from the at least one game server 10. The client interface 35 displays the game document 36 on the game display 37.

The game document 36 contains a trivia question, a crossword puzzle, or any other suitable game. The game document 36 preferably includes a graphic identifying a sponsor, a web address of the sponsor, a multimedia presentation and a game to be played. The sponsor pays a fee for the cost of sending the game document 36 to Internet users, so that the sponsor may advertise their product or service on the game display 37. The game document 36 is preferably an XML file, but other file types may also be used. A multimedia presentation of the sponsor's product or service is preferably displayed for a period of time, before the game is displayed. The Internet user will then have a chance to play a game or answer a question.

The application interface 30 includes the capability of picking a game or a question from the database of games 18. The game or question is converted into the game document by the game document builder, utilizing a game template from the game template database 38. The game template provides a form in which the game is arranged. The game document 36 is capable of being received by the game client 34. Picking of a game or question preferably occurs over random intervals of time. However, games and questions may also be manually retrieved by the some other appropriate control. The game document 36 is sent to a game queue 40 on the at least one game server 10. The application interface 30 constantly monitors the game queue 40. The application interface 30 is activated by reading a game document 36 in the game queue 40. The application interface 30 also decides, which Internet addresses in the users database 20 should receive the game document 36. The game document 36 is sent shortly after it appears in the game queue 40.

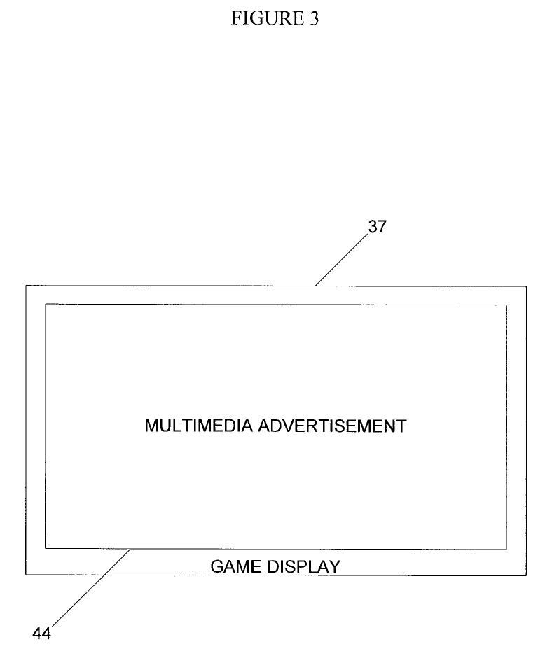

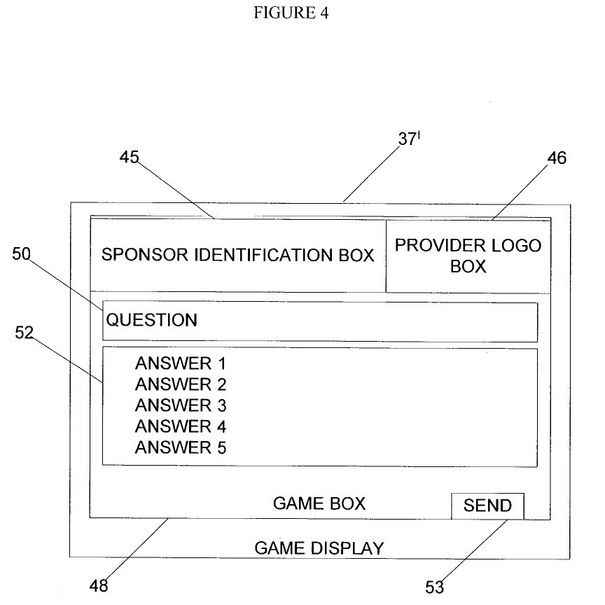

Preferably, a different selection of Internet users receive the game document 36 each time a new game document is sent out. An internet user must first click on a flashing icon 42 located in an icon tray to activate the game client 34. The client interface 35 receives the game document 36 and displays the game document in the game display 37. The icon 42 preferably flashes after the game document 36 has been received and loaded by the game client 34. It is preferable to allow an audible alert to be set in conjunction with the flashing icon. With reference to FIG. 3, a sponsor's multimedia advertisement 44 appears first in the game client 37. The multimedia advertisement 44 includes the promotion of a product or service and contact information, which may include a URL of the sponsor's website 43. With reference to FIG. 4, after the multimedia advertisement is completed; the appearance of the game display 37 is changed to display a game. A game display 37′ preferably includes a sponsor identification box 45, a provider logo box 46 and the game box 48. A question game is displayed in the game box 48. The question game includes a question box 50 and an answer box 52. The answer box 52 preferably lists a plurality of answers from which to choose. However, other types of games, such as a cross word puzzle may also be used for the game, besides the question game. The selected Internet users play the game or answer the question as soon as possible.

After the game is completed or the question answered, the Internet user clicks a send button 53 on the game display 37. The game display 37 sends a modified game document 54 to the at least one Internet game server 10, after the send button 53 is clicked. The application interface 30 reviews the modified game document 54 for a modified record. Those modified game documents 54 with a correct modified record are placed in a correct queue 58. Those modified game documents 54 with an incorrect modified record are placed in a non-winners queue 56. An answer evaluation program 32 reviews the Internet users placed in the correct queue 58 to make sure that the game was completed within a maximum period of time or a question was answered within a maximum period of time. Those users who completed the game or answered the question within the maximum time period are placed in an eligible winners queue 60. Those Internet users who didn't respond, before the maximum period of time are placed in the non-winners queue 56. Both winners and non-winners are notified by the application interface 30. Prize drawing software 62 determines at least one winner from the eligible winners queue 60. The at least one winner receives a prize. Interactive display advertising may also be referred to as a method of interactive display advertising.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of interactive display advertising comprising the steps of:
supplying a game client to a plurality of internet communication devices;
sending a game document to at least two of said plurality of internet communication devices;
displaying said game document in said game client;
displaying the name of said sponsor of said game document;
playing said game contained in said game document;
sending said game document to a game server after playing said game; and
awarding at least one prize based on the play of said game.

2. The method of interactive display advertising of claim 1, further comprising the step of:
including a multimedia advertisement in said game document, showing said multimedia advertisement before displaying said game.

3. The method of interactive display advertising of claim 1, further comprising the step of:
providing a flashing icon on each one of said plurality of internet communication devices to show that said game document has been received.

4. The method of interactive display advertising of claim 1, further comprising the step of:
charging said sponsor a fee for sending said game document.

5. The method of interactive display advertising of claim 1, further comprising the step of:
modifying said game document to produce a modified game document to show that play of said game has been completed.

6. The method of interactive display advertising of claim 5, further comprising the step of:
evaluating said modified game document to see if thereof has been submitted within a maximum amount of time.

7. The method of interactive display advertising of claim 5, further comprising the step of:
sending a notice back to each one of said plurality of internet communication devices concerning the timeliness of said modified game document submission.

8. The method of interactive display advertising of claim 1, further comprising the step of:
providing said game as a trivia question.

9. A method of interactive display advertising comprising the steps of:
supplying a game client to a plurality of internet communication devices;
sending a game document to at least two of said plurality of internet communication devices;
displaying said game document in said game client;
displaying the name of said sponsor of said game document;
playing said game contained in said game document;
modifying said game document to produce a modified game document to show that play of said game has been completed;
sending said modified game document to a game server; and
awarding at least one prize based on the submission of said game.

10. The method of interactive display advertising of claim 9, further comprising the step of:
including a multimedia advertisement in said game document, showing said multimedia advertisement before displaying said game.

11. The method of interactive display advertising of claim 9, further comprising the step of:
providing a flashing icon on each one of said plurality of internet communication devices to show that said game document has been received.

12. The method of interactive display advertising of claim 9, further comprising the step of:
charging said sponsor a fee for sending said game document.

13. The method of interactive display advertising of claim 9, further comprising the step of:
evaluating said modified game document to see if thereof has been submitted within a maximum amount of time.

14. The method of interactive display advertising of claim 9, further comprising the step of:
sending a notice back to each internet communication device concerning the timeliness of said modified game document submission.

15. The method of interactive display advertising of claim 9, further comprising the step of:
providing said game as a trivia question.

16. A method of interactive display advertising comprising the steps of:
providing at least one game server;
providing a plurality of internet communication devices;
installing a game client on each one of said plurality of internet communication devices;
sending a game document to at least two of said plurality of internet communication devices;
displaying said game document in said game client;
displaying the name of said sponsor of said game document, displaying a product or service that said sponsor provides;
playing said game contained in said game document;
sending said game document to a game server after playing said game; and
awarding at least one prize based on the play of said game.

17. The method of interactive display advertising of claim 16, further comprising the step of:
including a multimedia advertisement in said game document, showing said multimedia advertisement before displaying said game.

18. The method of interactive display advertising of claim 16, further comprising the step of:
providing a flashing icon on each one of said plurality of internet communication devices to show that said game document has been received.

19. The method of interactive display advertising of claim 16, further comprising the step of:
modifying said game document to produce a modified game document to show that play of said game has been completed.

20. The method of interactive display advertising of claim 19, further comprising the step of:
sending a notice back to each one of said plurality of internet communication devices concerning the timeliness of said modified game document submission.
